(19) United States
(12) Patent Application Publication
(10) Pub. No.: US 2014/0001416 A1
(43) Pub. Date: Jan. 2, 2014

(54) METHOD FOR PRODUCING POWDERY POLYMER/CARBON NANOTUBE MIXTURES

(71) Applicants: Egbert Fiffemeier, Leichlingen (DE); Benno Ulfik, Leverkusen (DE); Sabrina Horn, Bad Honnef (DE)

(72) Inventors: Egbert Fiffemeier, Leichlingen (DE); Benno Ulfik, Leverkusen (DE); Sabrina Horn, Bad Honnef (DE)

(73) Assignee: BAYER INTELLECTUAL PROPERTY GMBH, MONHEIM (DE)

(21) Appl. No.: 13/996,136

(22) PCT Filed: Dec. 19, 2011
(86) PCT No.: PCT/EP2011/073166

§ 371 Date: Sep. 23, 2013

(30) Foreign Application Priority Data
Dec. 21, 2010 (EP) 10196148.0

(51) Int. Cl. H01B 1/04

(52) U.S. Cl. CPC H01B 1/04; Y10S 977/783; Y10S 977/90; Y10S 977/932; B82Y 40/00
USPC 252/511; 977/783; 977/900; 977/932

(57) ABSTRACT

A method for producing and/or processing polymer/carbon nanotube mixtures in powder form comprises the step of grinding a mixture comprising carbon nanotubes and polymer particles. The grinding is carried out in the presence of from ≧0 weight-% to ≦15 weight-%, expressed in terms of the total weight of the mixture, of a liquid phase which does not dissolve the polymer particles and at a temperature below the melting point of the powder particles. The energy input during the grinding is preferably low. A preferred polymer is PVDF. The invention furthermore relates to polymer/carbon nanotube mixtures which can be obtained by a method according to the invention, and to the use of such polymer/carbon nanotube mixtures for the production of electrodes.

The present invention relates to a method for producing and/or processing polymer/carbon nanotube mixtures in powder form, comprising the step of grinding a mixture comprising carbon nanotubes and polymer particles.

The invention furthermore relates to polymer/carbon nanotube mixtures in powder form which can be obtained by a method according to the invention, and to the use of such polymer/carbon nanotube mixtures in powder form for the production of electrodes.

Carbon nanotubes (CNTs) are known for their extraordinary properties. Thus, for example, their strength is about 100 times that of steel, their thermal conductivity is approximately as great as that of diamond, their thermal stability can reach as high as 2800° C. in a vacuum and their electrical conductivity can be several times the conductivity of copper. These structurally induced characteristics, however, are often available at the molecular level only when it is possible to distribute carbon nanotubes homogeneously and establish maximal contact between the tubes and the medium, i.e. make them compatible with the medium and therefore stably dispersible.

With respect to electrical conductivity, it is furthermore necessary to form a network of tubes in which, in the ideal case, they touch, or come sufficiently close, only at the ends. In this case, the carbon nanotubes should, as far as possible, be individualised, i.e. agglomerate-free, not aligned and present in a concentration at which such a network can just be formed, which is reflected by an abrupt rise in the electrical conductivity as a function of the concentration of carbon nanotubes (percolation limit).

In order to achieve improved mechanical properties of composites, such as are observed, for example, in reactive resins such as epoxides, excellent dispersion and individualisation of carbon nanotubes is necessary since sizeable agglomerates lead to fracture sites (Zhou, eXPRESS Polym. Lett. 2008, 2, 1, 40-48) and a degradation of the mechanical properties of such composites is then observed instead.

The use of carbon nanotubes in lithium ion batteries is known. Thus, for example, WO 95/07551 A1 describes a lithium ion battery which is characterised in that the anode is formed from a carbon fibril material which comprises fibril aggregates or non-aggregated fibril masses having an average particle diameter of from 0.1 to 100 micrometres. In this case, fine, cord-shaped carbon fibrils having a diameter of from 3.5 to 70 nm are intertwined and the fibrils are intercalated with lithium. The cathode likewise comprises carbon fibrils.

In another example, EP 2 081 244 A1 discloses an electrode having a current collector and an active material layer arranged thereon. The active material layer includes a structural network and an active material composition. The structural network includes a network of carbon nanotubes and a binder. The active material composition includes an active material and a polar medium.

During the production of carbon nanotubes by the fluidised bed method, macroscopic aggregates/agglomerates are formed owing to the process, with sizes sometimes in the millimetre range. Furthermore, distinction is not made between agglomerates and aggregates. When using carbon nanotubes for lithium ion batteries, it is advantageous to achieve uniform distribution of the carbon nanotubes. Mechanical size-reduction is often employed for this, for example in ball mills, grinding mills, roll mechanisms or jet dispersers.

According to U.S. Pat. No. 6,528,211, a composite material for battery electrodes comprises fibre agglomerates having micropores and an active electrode material inside the micropores. The agglomerates are formed by entangled vapour-grown carbon fibres having contact points between the fibres. At least some of the contact points are chemically bonded contact points. The fibre agglomerates are produced by branched carbon fibres grown from the vapour phase being compressed and pulverised.

WO 2009/105863 discloses a material for composite electrodes, having a carbon-coated complex oxide, carbon fibres and a binder. The material is produced by an active electrode material and fibrous carbon being co-ground and by adding a binder to the co-ground mixture, in order to reduce the viscosity of the mixture. The fibrous carbon is preferably vapour-grown fibrous carbon. It is furthermore described that the binder is added in the form of a solution in a suitable solvent after the co-grinding.

In these mechanical size-reduction methods, the observation has been made that finely distributed dust is generated which is undesirable in terms of health and safety at work. It has furthermore been observed that the carbon nanotube material is deposited significantly on the surfaces of the grinding vessel and the grinding bodies and therefore has to be laboriously removed after the grinding process. Furthermore, very inhomogeneous powders are often produced, which also comprise graphitic platelets in the macroscopic size ranges. Lastly, it has been found that the fairly small carbon nanotube aggregates obtained after the grinding are susceptible to re-aggregation over the course of a few days.

Another important point is that these size-reduction methods require a comparatively large amount of energy in order to achieve the desired size-reduction results.

It was therefore the object of the present invention to at least partially overcome the disadvantages of the prior art. In particular, it was the object of the invention to provide a method with which commercially available carbon nanotube aggregates can be reduced in size with little energy expenditure, and the products obtained can be handled more safely and can be used in the production of lithium ion secondary cells or other electrochemical applications without changing existing methods.

Carbon nanotube compositions are furthermore to be provided which give stable dispersions after absorption in a suitable solvent.

The object is achieved according to the invention by a method for producing and/or processing polymer/carbon nanotube mixtures in powder form, comprising the step of grinding a mixture comprising carbon nanotubes and polymer particles having an average particle size of from ≧0.001 mm to ≦10 mm.

The method is distinguished in that the grinding is carried out in the presence of from ≧0 weight-% to ≦15 weight-%, expressed in terms of the total weight of the mixture, of a liquid phase which does not dissolve the polymer particles and at a temperature below the melting point of the polymer particles.

Surprisingly, it has been found that simple low-energy grinding methods can be used for the method according to the invention, without compromising the grinding result. The polymer/carbon nanotube mixtures in powder form which are obtained show significantly reduced dust susceptibility, are pourable and do not adhere to the walls of the grinding vessel or other parts of the grinding mechanism.

Lastly, it has been found that the polymer/carbon nanotube mixtures in powder form which are obtained by the method according to the invention provide, after dispersion in an appropriate solvent, stable dispersions in which no sedimentation or only technically insignificant sedimentation takes place.

The transition between low-energy grinding and the intermixing of powders is not clear-cut. According to the invention, therefore, mixing of the individual powders of the mixture is also included in the term “grinding” so long as size-reduction of any carbon nanotube aggregates that may be present takes place. The grinding may also be carried out with mixers which cause a grinding effect.

In the method according to the invention, the grinding is carried out in the presence of from ≧0 weight-% to ≦15 weight-%, expressed in terms of the total weight of the mixture, of a liquid phase which does not dissolve the polymer particles. Of course, no other liquid phase which dissolves the polymer particles is present.

A solution of the polymer is therefore not obtained, but instead solid polymer particles and solid carbon nanotubes and/or CNT aggregates are dispersed together in this liquid phase. The comparatively small amount of liquid phase can ensure that possible dust generation is prevented before the grinding process, for example by the carbon nanotubes being provided in this liquid phase. An example of a non-dissolving liquid phase is ethanol in the case of polymer particles made of PVDF. However, it is also possible to entirely dispense with the liquid phase and carry out dry grinding.

Furthermore, it is envisaged that the grinding be carried out at a temperature below the melting point of the polymer particles. This also ensures that solid carbon nanotubes and/or carbon nanotube aggregates and solid polymer particles come into mechanical contact with one another during the grinding. In the event that the polymer particles have a melting range instead of a melting point, the grinding should be carried out at a temperature below the lowest temperature of the melting range.

It is in principle possible to operate at room temperature, below room temperature or at elevated temperature, so long as the polymer is not melted. Thus, for example, cooling may be useful in order to cause the polymer to become brittle and thereby influence its behaviour during the grinding process. A higher temperature would have advantages when stronger adhesion of the carbon nanotubes and/or carbon nanotube aggregates to the polymer particles is desired.

It is likewise possible for the temperature of the material being ground to be varied during the grinding. For instance, it is feasible to grind initially at a first temperature and then at a second temperature, the first temperature being lower than the second temperature. Temperature gradients during the grinding process may also be envisaged.

In the method according to the invention, it is in principle possible to use all grinding devices. One advantage is that even simple devices can be used since the powder mixtures obtained are still pourable.

Pourability refers to the extent of free mobility or the flow behaviour of bulk materials. In particular, the mixtures in powder form which are obtained after the grinding show good pourability. The flow index of these mixtures may be >10 ml/s, more expediently >15 ml/s, preferably >20 ml/s and particularly preferably >25 ml/s (determinable with the pourability tester from the company Karg-Industrietechnik (Code No 1012.000) Model PM and a 15 mm nozzle according to the standard ISO 6186). Pourable mixtures offer significant advantages for their dosing and processing.

The polymer particles may in principle be composed of any desired polymers, including additives such as fillers or the like which may be present. It is favourable for the polymer material to play a part in the desired further processing of the carbon nanotubes. For example, the polymer may be a binder.

According to the invention, it is envisaged that the polymer particles have an average particle size of from ≧0.001 mm to ≦10 mm. This value can generally be determined by means of laser diffraction spectrometry (one example of a device is the Mastersizer MS 2000 with Hydro S dispersing unit from the company Malvern; in water). A preferred size range is from ≧0.02 mm to ≦6 mm. More preferably, the average particle size is from ≧0.05 mm to ≦2 mm, and particularly preferably from ≧0.1 mm to ≦1 mm.

The carbon nanotubes in the method according to the invention may be present in agglomerated form and/or in non-agglomerated form and/or in aggregated form and/or in non-aggregated form.

Carbon nanotubes within the meaning of the invention are all single-walled or multi-walled carbon nanotubes of the cylinder type (for example in the patents of Iijima U.S. Pat. No. 5,747,161; Tennant WO 86/03455), scroll type, multi-scroll type, cup-stacked type consisting of conical cups closed on one side or open on both sides (for example in patents Geus EP 198558 and Endo U.S. Pat. No. 7,018,601), or with an onion-type structure. Multi-walled carbon nanotubes of the cylinder type, scroll type, multi-scroll type and cup-stacked type or mixtures thereof are preferably used. It is favourable for the carbon nanotubes to have a ratio of length to external diameter of ≧5, preferably >100.

In contrast to the aforementioned known carbon nanotubes of the scroll type having only one continuous or interrupted graphene layer, there are also carbon nanotube structures that consist of a plurality of graphene layers, which are combined to form a stack and rolled up. This is referred to as the multi-scroll type. These carbon nanotubes are described in DE 10 2007 044031 A1, to which reference is made in its entirety. This structure behaves, with respect to the carbon nanotubes of the single-scroll type, in a manner comparable to the way in which the structure of multi-walled cylindrical carbon nanotubes (cylindrical MWNTs) behaves with respect to the structure of single-walled cylindrical carbon nanotubes (cylindrical SWNTs).

Unlike in the case of the onion-type structures, the individual graphene or graphite layers in these carbon nanotubes, as seen in cross section, clearly extend continuously from the centre of the carbon nanotubes to the outer edge without interruption. This can, for example, permit improved and more rapid intercalation of other materials in the tube framework, since more open edges are available as an entry zone for the intercalates, compared to carbon nanotubes with a single-scroll structure (Carbon 1996, 34, 1301-3) or carbon nanotubes with an onion-type structure (Science 1994, 263, 1744-7).

Embodiments of the method according to the invention will be explained below; the embodiments may be combined with one another in any desired way unless the context unequivocally implies the contrary.

In one embodiment of the method according to the invention, the carbon nanotubes are present in the form of carbon nanotube agglomerates/aggregates having an average agglomerate/aggregate size of from ≧0.001 mm to ≦10 mm.

This agglomerated form is the form of carbon nanotube in which they are in general commercially available. Distinction can be made between several structural types of agglomerates (see, for example, Moy U.S. Pat. No. 6,294,144): the bird's nest (BN) structure, the combed yarn (CY) structure and the open net (ON) structure. Further agglomerate structures are known, for example one in which the carbon nanotubes are arranged in the form of bulked yarns (Hocke WO PCT/EP2010/004845). Further described are nanotubes which are aligned in a parallel manner over surfaces in the form of carpets or forests, so-called forest structures (for example in patents Dai U.S. Pat. No. 6,232,706 and Lemaire U.S. Pat. No. 7,744,793). Here, the neighbouring tubes are predominantly aligned in a mutually parallel manner. The aforementioned agglomerate forms may also be mixed with one another in any desired way or used as a mixed hybrid, that is to say different structures within one agglomerate.

The agglomerates preferably have an average agglomerate size of ≧0.02 mm. This value can generally be determined by means of laser diffraction spectrometry (one example of a device is the Mastersizer MS 2000 with Hydro S dispersing unit from the company Malvern; in water). The upper limit of the agglomerate size is preferably ≦10 mm and particularly preferably ≦6 mm. More preferably, the average agglomerate size is from ≧0.05 mm to ≦2 mm and more particularly preferably from ≧0.1 mm to ≦1 mm.

In another embodiment of the method according to the invention, the grinding is carried out in the presence of from ≧0 weight-% to ≦1 weight-%, expressed in terms of the total weight of the mixture, of the liquid phase. The proportion of the liquid phase is preferably from ≧0 weight-% to ≦0.1 weight-% and more preferably from ≧0 weight-% to ≦0.01 weight-%. Overall, a dry grinding process may then be referred to, although technically unavoidable moisture traces are also included.

According to the invention, the energy introduced during the grinding should be so low that undesired shortening of the carbon nanotubes, particularly in carbon nanotube aggregates, does not take place or takes place only to an insignificant extent. The energy input can be determined with the aid of the power consumption of the motor used in the grinding device. In particular embodiments, this may be a grinding energy input of ≦0.1 kWh/kg, expressed in terms of the mixture comprising carbon nanotube agglomerates and polymer particles, and in other embodiments ≦0.05 kWh/kg or ≦0.01 kWh/kg.

In another embodiment of the method according to the invention, the grinding is carried out at a temperature of from ≧−196° C. to ≦180° C. In this case, of course, the melting point of the polymer particles is not to be exceeded. Preferred temperatures lie in the range of from ≧−40° C. to ≦100° C. In this way, for example, it is possible to operate both above and below the glass transition temperature of the polymer polyvinylidene fluoride which is preferably used (depending on the precise material, from −40° C. to −30° C.).

In another embodiment of the method according to the invention (if the carbon nanotubes are present in the form of carbon nanotube agglomerates), the grinding is carried out in such a way that the average agglomerate size of the carbon nanotube agglomerates after the grinding is from ≧0.01 μm to ≦20 μm. As already explained above, the size of the aggregates can be determined by means of laser diffraction spectrometry. Preferred aggregate sizes after the grinding, specifically with a view to electrode materials, are from ≧0.1 μm to ≦10 μm and more preferably from ≧1 μm to ≦7 μm.

In another embodiment of the method according to the invention (if the carbon nanotubes are provided in the form of CNT agglomerates), the grinding is carried out in such a way that the BET surface of the carbon nanotube agglomerates after the grinding is from ≧25 m²/g to ≦50 m²/g, from ≧50 m²/g to ≦150 m²/g or from ≧150 m²/g to ≦400 m²/g. Such BET surface values are good indicators that shortening of the CNT fibrils, which is undesirable in applications for electrode materials, has not taken place or has taken place only to an insignificant extent. The BET surfaces preferably lie in the range of from ≧80 m²/g to ≦120 m²/g and more preferably from ≧90 m²/g to ≦110 m²/g, and likewise preferably in the range of from ≧120 m²/g to ≦400 m²/g. The BET surface may be determined by means of nitrogen adsorption according to the multipoint BET method at −196° C. (similarly to DIN ISO 9277).

In another embodiment of the method according to the invention, the carbon nanotubes and the polymer particles are present in a weight ratio of from ≧0.05:1 to ≦20:1. This ratio is preferably from ≧0.75 to ≦1.5:1 and particularly preferably from ≧0.9:1 to ≦1.1:1. In these weight ratios, the carbon nanotube/polymer mixtures obtained can be used without modifications in the production of electrode materials, the polymer fulfilling the function of the binder used.

In another embodiment of the method according to the invention, the carbon nanotubes are multi-walled carbon nanotubes having an average external diameter of from ≧3 nm to ≦100 nm, preferably from ≧5 nm to ≦25 nm, and a ratio of length to diameter of ≧5, preferably ≧100.

In another embodiment of the method according to the invention, the polymer particles comprise polymers which are selected from the group comprising poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, copolymers of polyhexafluoropropylene and polyvinylidene fluoride, poly(ethyl acrylate), polytetrafluoroethylene, polyvinyl chloride, polyacrylonitrile, polyvinyl pyridine, polyethylene, polypropylene, styrene-butadiene copolymers and/or polystyrene and/or copolymers thereof. Polyvinylidene fluoride (PVDF) is preferred.

In another embodiment of the method according to the invention, in an additional step the polymer/carbon nanotube mixture in powder form, obtained after the grinding, or the polymer/carbon nanotube mixture obtained comprising up to 15 weight-% of liquid phase, is dispersed in a solvent. The mixture obtained, or the dispersion obtained, can then be used directly as a binder-containing formulation for the production of electrode materials. The polymer is preferably dissolved in the solvent.

The solvent is preferably selected from the group comprising lactams, ketones, nitriles, alcohols, cyclic ethers and/or water. It is still more preferable for the solvent to be N-methylpyrrolidone, which is a suitable solvent for PVDF. Stable dispersions of the size-reduced carbon nanotubes and/or carbon nanotube aggregates in PVDF can, in this way, be further processed directly in the production of electrode materials. Compared to the conventional route of grinding without polymers, dissolving the polymeric binder and dispersing the carbon nanotube aggregates, it has been found that an energy saving can be achieved in the method according to the invention.

The present invention further provides polymer/carbon nanotube mixtures in powder form, or polymer/carbon nanotube mixtures comprising up to 15 weight-% of liquid phase, which can be obtained by a method according to the invention. It is highly preferable for the mixtures to be dry mixtures, which is understood to mean mixtures having a proportion of from ≧0 weight-% to ≦1 weight-% of a liquid phase, expressed in terms of the total weight of the mixture.

With respect to details and preferred embodiments, reference is made to the comments above in order to avoid repetition.

The present invention further provides the use of polymer/carbon nanotube mixtures in powder form, or polymer/carbon nanotube mixtures comprising up to 15 weight-% of liquid phase, according to the invention for the production of electrodes. As already explained, a solvent for the polymer may then be added to the previously obtained, preferably dry mixtures, so as for example to produce conductive pastes, optionally together with other electrochemically active compounds.

In a preferred use of the mixtures, the electrodes are electrodes for photovoltaic cells, preferably photoelectrochemical solar cells, fuel cells, electrolysers, thermo electrochemical cells, accumulators and/or batteries. Lithium ion secondary cells are preferred in this case.

The invention likewise relates to the electrodes produced in this way, which can be obtained by using a polymer/carbon nanotube mixture in powder form according to the invention, or a polymer/carbon nanotube mixture comprising up to 15 weight-% of liquid phase according to the invention.

The present invention will be explained in more detail with the aid of the following examples and figures, but without being restricted thereto.

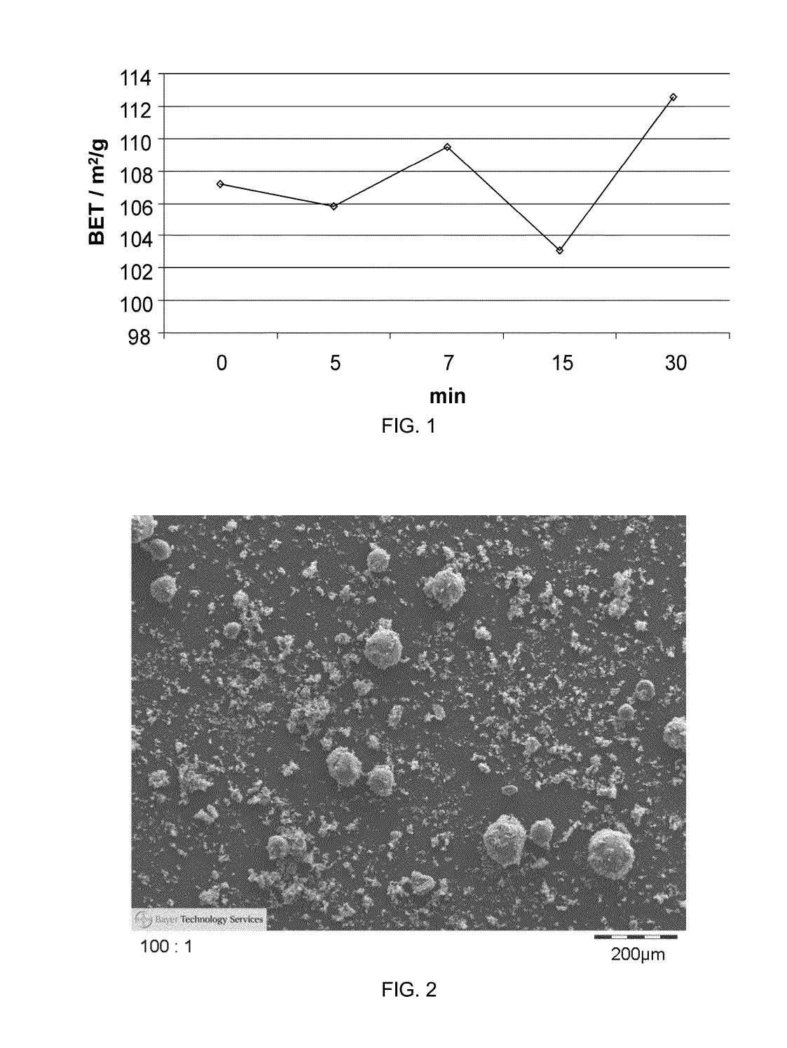

FIG. 1 shows the dependency of the BET surface on the grinding time in a method according to the invention

FIGS. 2-4 show scanning electron microscope images of mixtures obtained in a method according to the invention

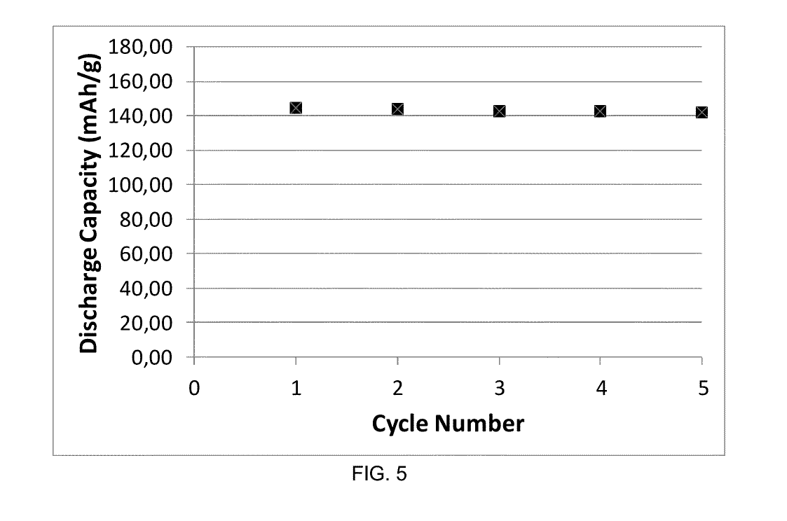

FIG. 5 shows the discharging capacity of an electrode obtained in a method according to the invention.

### APPLICATION EXAMPLES OF THE GRINDING OF CARBON NANOTUBES WITH PVDF

### Definitions

Carbon nanotubes: Baytubes® C150HP from the company Bayer MaterialScience. These are multi-walled carbon nanotubes having an average external diameter of from 13 nm to 16 nm and a length of more than 1 μm. They are furthermore present in the form of agglomerates/aggregates having an average particle size of from 0.1 mm to 1 mm.

PVDF: Polyvinylidene fluoride from the company Solvay Solexes. The material has a melting range (ASTM D 3418) of 155-172° C. and an average particle size of <180 μm.

In each case, 2 g of carbon nanotubes and 2 g of PVDF were introduced into an analysis mill of the type A10 Janke and Kunkel (IKA). The rotor consisted of a paddle with two blades having a diameter of 55 mm. The rotation speed of the rotor was 20000/min with a maximum circumferential velocity of 58 m/s. During the grinding, the mill was cooled by a water circuit so that the temperature did not rise above the melting point of the polymer being used.

For each new test, the grinding time was varied in order to systematically study the effect of the grinding time on the materials being ground. Important parameters for the materials being ground are the optical impression (homogeneity, pouring behaviour), the particle size distribution of the CNT aggregates, the BET surface and the microscopic appearance.

It was possible to establish that, even after a short grinding time, a highly pourable optically homogeneous powder was obtained which could be removed easily from the grinding vessel. In comparative tests without the addition of PVDF, it was observed that platelets resembling graphite, which could be removed only by strong mechanical force, were formed on the container wall. It was furthermore observed that the dust formation during the grinding with PVDF was much less than when grinding CNTs without PVDF.

The determination of the particle size distribution in N-methylpyrrolidone (NMP) was able to show that, even after a grinding time of 5 minutes, a minimum average particle size (determination by laser diffraction; cumulative parts of volume [%]) of 5-6 μm was achieved, which did not further decrease significantly with longer grinding times. This value was determined by stirring the powder into NMP without further treatment, such as, for example, with ultrasound.

An optical inspection revealed no visible sedimentation of CNT aggregates in these samples.

For the properties of CNTs, it is favourable that the individual carbon nanotubes are not degraded in respect of their application properties by the grinding process. Undamaged (defect-free) and maximally long carbon nanotubes have outstanding electrical and mechanical properties. In order to study and ensure this, the BET surfaces of the samples were determined after different grinding times.

A significant increase in the BET surface is, in this case, a clear indication of damage to the CNTs. This is based on the assumption that the increase in the BET surface is caused by CNT fragments and changes in the morphology (defects).

In a separate comparative series of tests, it was possible to show that the BET surface is more than doubled from 186 m²/g to 427 m²/g after a short time by a high-energy mechanical treatment in a planetary mill without PVDF.

FIG. 1 represents the profile of the BET surface of CNT aggregates in a mixture with PVDF after grinding according to the invention as a function of the grinding time. The measurement value at 0 min was determined by determination on a CNT/PVDF sample which was prepared by simple manual mixing without further mechanical treatment. The determination was carried out by nitrogen adsorption according to the multipoint BET method at −196° C. (similarly to DIN ISO 9277).

As can be seen in FIG. 1, the values are spread around a value of about 106 m² μg, almost independent of the grinding time, with a tendency towards higher values after 30 min. This, however, is in significant contrast to the rises which were observed in the comparative series of tests.

An important indication of the positive effect of the polymer during the grinding of CNT aggregates is provided by the scanning electron microscope images in FIGS. 2 to 4. All the samples mentioned in the examples described above were also characterised in a corresponding way.

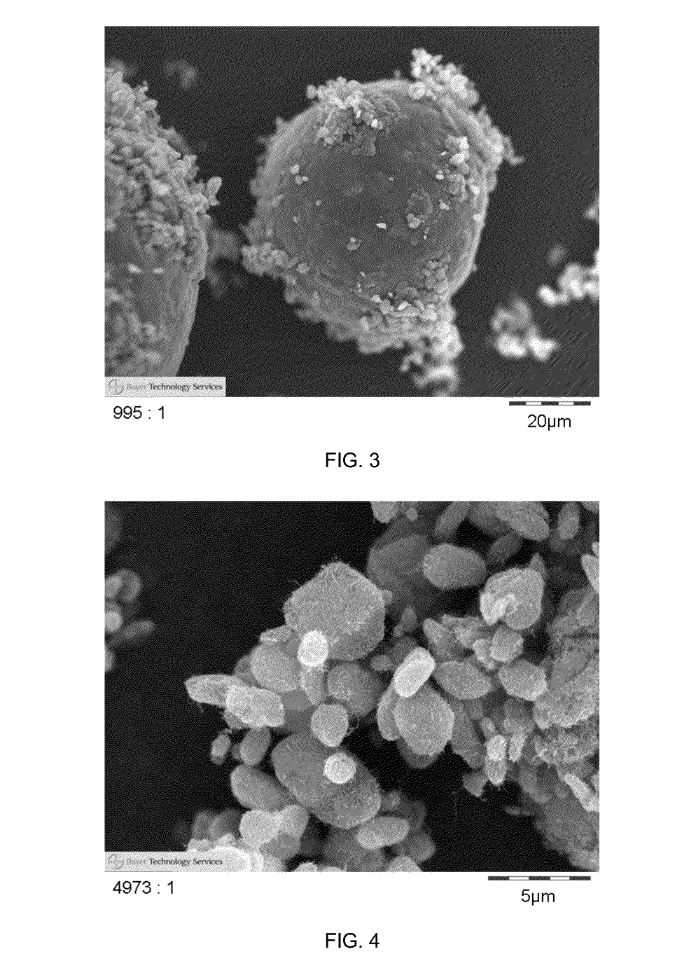

By way of example, a sample is initially represented in two images at different magnifications after a grinding time of 7 minutes. In FIG. 2, with a magnification of 100:1, relatively large polymer particles having diameters in the range of between 50 μm and 100 μm can be identified in addition to the much smaller CNT aggregates. This can likewise be seen clearly in FIG. 3 with a magnification of 995:1.

According to FIG. 4 with a magnification of 4973:1, the particles can be identified unequivocally as CNT aggregates. Individual CNT fibrils can already be seen on the surface.

Without being restricted to a theory, it will be assumed that adhesion of the CNT aggregates represents an explanation of the reduced dust formation achieved in the method according to the invention, the reduced re-aggregation during the grinding of CNT aggregates with PVDF and the improved pouring behaviour of the powder samples.

### APPLICATION EXAMPLE OF THE PRODUCTION OF AN ELECTRODE FOR BATTERIES

6 g of the polymer/carbon nanotube mixture in powder form previously prepared according to the invention were dispersed with the solvent N-methylpyrrolidone using a dissolver disc (40 mm diameter). The rotational speed of the high-power stirrer was 2000 rpm for a duration of 1.5 hours. In a final step, 45 g of active material NM3100 (LiNiO_{0.33}Co_{0.33}MN_{0.33}O₂) from the company Toda Kogyo were added to the dispersion, and dispersing was carried out for a further 1.5 hours at 700 rpm. Dispersion was carried out in a double-walled temperature-controlled vessel, so that the temperature could be set to 23° C. The paste produced was then spread with a wet film thickness of 250 μm onto an aluminium foil. This film was dried overnight at 60° C. in a circulated air conditioning cabinet. Cathodes for battery manufacture were produced from the dried film by stamping. The discharge properties of the electrodes produced in this way were measured in half-cell measurements with Li foil as the anode, using a plurality of charging/discharging cycles, and are represented by way of example in FIG. 5.

1. Method for producing and/or processing polymer/carbon nanotube mixtures in powder form, comprising the step of grinding a mixture comprising carbon nanotubes in aggregated form and/or in non-aggregated form and polymer particles having an average particle size of from ≧0.001 mm to ≦10 mm; wherein
the grinding is carried out in the presence of from ≧0 weight-% to ≦15 weight-%, expressed in terms of the total weight of the mixture, of a liquid phase which does not dissolve the polymer particles and at a temperature below the melting point of the polymer particles.

2. Method according to claim 1, wherein the carbon nanotubes are provided in the form of carbon nanotube agglomerates having an average agglomerate size of from ≧0.001 mm to ≦10 mm.

3. Method according to claim 1, wherein the grinding takes place at a temperature of from ≧−196° C. to ≦180° C.

4. Method according to claim 2, wherein the average agglomerate size of the carbon nanotube agglomerates after the grinding is from ≧0.01 μm to ≦20 μm.

5. Method according to claim 1, wherein the BET surface of the carbon nanotubes after the grinding is from ≧25 m²/g to <50 m²/g, from ≧50 m²/g to ≦150 m²/g or from >150 m²/g to ≦400 m²/g.

6. Method according to claim 1, wherein the carbon nanotubes and the polymer particles are provided in a weight ratio of from ≧0.05:1 to ≦20:1.

7. Method according to claim 1, wherein the carbon nanotubes are multi-walled carbon nanotubes having an average external diameter of from ≧3 nm to ≦100 nm and a ratio of length to diameter of ≧5.

8. Method according to claim 1, wherein the polymer particles comprise polymers which are selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, copolymers of polyhexafluoropropylene and polyvinylidene fluoride, poly(ethyl acrylate), polytetrafluoroethylene, polyvinyl chloride, polyacrylonitrile, polyvinyl pyridine, polyethylene, polypropylene, styrene-butadiene copolymers, polystyrene and copolymers thereof.

9. Polymer/carbon nanotube mixtures in powder form, or polymer/carbon nanotube mixtures comprising up to 15 weight-% of liquid phase, obtained by the method of claim 1.

10. Method according to claim 1, further comprising a step in which the polymer/carbon nanotube mixture in powder form, obtained after the grinding, or the polymer/carbon nanotube mixture, obtained after the grinding, comprising up to 15 weight-% of liquid phase, is dispersed in a solvent.

11. Method according to claim 10, wherein the solvent is selected from the group consisting of lactams, ketones, nitriles, alcohols, cyclic ethers and/or water.

12. Method according to claim 11, wherein the solvent is N-methylpyrrolidone.

13. A Dispersion, obtained by the method of claim 10.

14. A method for producing electrodes, which comprises producing said electrodes from the polymer/carbon nanotube mixtures in powder form, or polymer/carbon nanotube mixtures comprising up to 15 weight-% of liquid phase of claim 9.

15. An electrode obtained from the polymer/carbon nanotube mixture in powder form, or polymer/carbon nanotube mixture comprising up to 15 weight-% of liquid phase, of claim 9.

16. Method of claim 14, wherein the electrodes are electrodes for photovoltaic cells, accumulators, fuel cells, electrolysers, thermo electrochemical cells or batteries.

17. An electrode obtained from the dispersion of claim 13.
